(19) United States
(12) Patent Application Publication
(10) Pub. No.: US 2019/0255611 A1
(43) Pub. Date: Aug. 22, 2019

(54) METAL-BASED PELLET EXTRUSION ADDITIVE MANUFACTURING SYSTEM AND METHOD OF USING SAME

(71) Applicant: Greenheck Fan Coproration, Scholfield, WI (US)

(72) Inventors: Thomas Frank, Schofield, WI (US); Jason Miller, Houston, TX (US); Matthew Keener, Schofield, WI (US); Rick Johnson, Schofield, WI (US)

(21) Appl. No.: 16/280,682

(22) Filed: Feb. 20, 2019

Related U.S. Application Data
(60) Provisional application No. 62/632,951, filed on Feb. 20, 2018.

(51) Int. Cl. B22F 3/00; B33Y 10/00; B33Y 30/00; B33Y 70/00; B28B 1/00; B29C 64/165; B29C 64/209

(52) U.S. Cl. CPC B22F 3/008; B33Y 10/00; B33Y 30/00; B29C 64/209; B28B 1/001; B29C 64/165; B33Y 70/00

(57) ABSTRACT

An example of a metal-based pellet extrusion additive manufacturing system is disclosed. The system may include a printing nozzle system with a turnable screw, an extruder body, and a nozzle end, wherein the turnable screw is configured to transport metal-based pellets from an extruder body towards a nozzle end. A method for fabricating an object using metal-based pellet extrusion system is also disclosed. In one example, the additive manufacturing system and method are utilized to form a fan wheel for a fan assembly. In some implementations, the fan wheel is a monolithic part without any welds or other attachment features joining fan blades of the fan wheel to the base of the fan wheel.

### RELATED APPLICATIONS

This application claims priority to U.S. Provisional Application Ser. No. 62/632,951, filed on Feb. 20, 2018, the entirety of which is incorporated by reference herein.

### FIELD

Embodiments are in the field of additive manufacturing. More particularly, embodiments disclosed herein relate to additive manufacturing systems and methods for utilizing metal-based pellet extrusion in an additive manufacturing system.

### BACKGROUND

Additive manufacturing or three-dimensional (3D) printing machines are known. Many such machines use a feedstock provided in filament form. While there are many variants of 3D printers, the three most common technologies are 1) Fused filament fabrication (FFF); 2) Powdered bed additive manufacturing (PAM); and 3) Stereolithography (SL) or Stereolithography apparatus (SLA). Within PAM, laser sintering or jetting technology are dominant techniques. In SL, a liquid pool of material is catalytically polymerized in a liquid material bath to yield a solid part.

There are advantages and disadvantages to all of the 3D printing techniques. However, the one thing they all have in common is the very high cost of the final printed part. The current state-of-the-art in 3D printed parts have a very high cost when measured as a cost per unit ($/unit), or unit cost per pound of material ($/pound) relative to other manufacturing processes. To be succinct, the parts have a high “dollar density”. Of course, if the part cannot be made any other way, then the higher cost might be justified. Dollar dense parts are much more common in specialty markets such as aerospace, biomedical, military, or space exploration.

As mentioned, a common characteristic for specialty market parts is the cost of the material. FFF typically uses a polymer or composite filament as the feedstock. And while the polymer used to manufacture the filament might be common, the market price for well-known and somewhat common polymers in a filament form can be quite high.

Most common polymers are available in the form of a pellet. Additionally, it is common to use a pellet-form to manufacture filaments. A common polymer pelletized material might be $2-$4 per pound. The same material in a filament form might sell for $30-$50 per pound. Similar disparities in material cost exist for PAM and SLA. The material selection of filament feedstock is also relatively limited compared to pellets. While it is expected that filament pricing will decrease over time, it is unlikely that the filament cost will ever be as low as the cost of pellets.

SLA is used with polymer-based materials that can be processed as a liquid. High specific gravity material, like metals, are not compatible with SLA methodologies, manufacturing, or equipment. PAM materials are just that, the material is in a powder form. The polymer powder particle size, shape, and particle size distribution must be closely controlled to allow PAM to work properly. These variables add to the cost.

PAM is more versatile than SLA because PAM can be used to process polymer or metal powders. FFF is widely known primarily for its polymer-based filaments. However, the filaments become increasingly difficult to manufacture when the polymer is a highly filled compound. It is known that an FFF filament can also be made using metal as a filler. However, metal-filled polymer filaments tend to be very brittle and extremely difficult to process. This decreases machine and material yield and slows the 3D printing processing time down considerably.

Finally, in large part, FFF filaments are also a limiting factor to the speed of the machine thus lowering machine throughputs. The filament process, whereby the filament is pulled into the machine before further processing is limited by the material itself. Highly elastic filament materials will stretch and deform causing the machine to not operate properly. Filaments exposed to higher heat will result in a similar failure mode. Conversely, low elastic, highly filled filaments are relatively brittle and break, causing the machine to stop functioning. FFF material cost is high, machine throughputs are low, and highly filled materials are difficult to process. Highly filled metal filaments present similar problems as other highly filled polymers. Thus, it is desirable to provide a 3D printer and method of using same that are able to overcome the above disadvantages.

### SUMMARY

An example of a metal-based pellet extrusion additive manufacturing system is disclosed. The system may include a printing nozzle system with a turnable screw, an extruder body, and a nozzle end, wherein the turnable screw is configured to transport metal-based pellets from an extruder body towards a nozzle end. A method for fabricating an object using metal-based pellet extrusion system is also disclosed. The method may include feeding metal-based pellets to an printing nozzle system; receiving the metal-based pellets in an extruder body of the printing nozzle system; providing an extruder, such as a turnable screw, in the printing nozzle system to force the pellets through the extruder body; extruding the metal-based pellets and heating the extruded pellets using one or more heaters during transport of the extruded pellets through the extruder body; dispensed the extruded metal-based pellets through a nozzle; and depositing the extruded metal-based pellets onto a printing surface to form a printed object. The method further includes debinding and sintering the printed object.

A method of producing a fan wheel for a fan assembly can include receiving metal-based pellets at a printing assembly including a nozzle and an extruder, the pellets including a metal material and a binder material, extruding and heating the metal-based pellets at the extruder to convert the metal-based pellets to a liquid state material, dispensing the liquid state material from the nozzle to print the fan wheel, the fan wheel being a monolithic object including a base and a plurality of fan blades.

In one example, the dispensing step includes printing the base to have a hollow shape.

In one example, the dispensing step includes printing the base to have a truncated dome-shape or a frustoconical shape and includes printing the fan blades to have an airfoil shape.

In one example, the method further includes debinding the fan wheel to remove a primary binder of the binder material from the fan wheel, and sintering the fan wheel to remove a skeletal binder of the binder material to densify the fan wheel.

In one example, the metal material is a stainless steel material, the primary binder is polyoxymethylene and the skeletal binder is polyethylene.

### BRIEF DESCRIPTION OF THE DRAWINGS

The foregoing summary, as well as the following detailed description, will be better understood when read in conjunction with the appended drawings. For the purpose of illustration only, there is shown in the drawings certain embodiments. It's understood, however, that the inventive concepts disclosed herein are not limited to the precise arrangements and instrumentalities shown in the figures.

FIG. 1 is a schematic perspective view of an additive manufacturing printing machine having features in accordance with the present invention.

FIG. 2 is another schematic perspective view of the additive manufacturing printing machine shown in FIG. 1.

FIG. 3 is a perspective view of the additive manufacturing printing machine, specifically, a printing head assembly, and a partly finished metal product extruded from the printing machine.

FIG. 4 is a schematic frontal view of an exemplary fan wheel for a fan assembly producible by the disclosed additive manufacturing printing machine shown in FIG. 1 and the processes disclosed herein.

FIG. 5 is a schematic of a control system of the printing machines shown in FIGS. 1-3

FIG. 6 is a rear view of a finished product extruded from the printing nozzle system disclosed.

FIG. 7 is a schematic frontal view of an exemplary fan wheel for a fan assembly producible by the disclosed additive manufacturing printing machine shown in FIG. 1 and the processes disclosed herein.

FIG. 7A is a schematic frontal view of an exemplary fan wheel for a fan assembly producible by the disclosed additive manufacturing printing machine shown in FIG. 1 and the processes disclosed herein.

FIG. 8 is a cross-sectional side view of a printing nozzle system for a metal-based pellet extrusion additive manufacturing system, in accordance with an embodiment.

FIG. 9 is another cross-sectional side view of the printing nozzle system shown in FIG. 8 for a metal-based pellet extrusion additive manufacturing system, in accordance with an embodiment.

FIG. 10 is another cross-sectional side view of the printing nozzle system 100 shown in FIG. 8 for a metal-based pellet extrusion additive manufacturing system, in accordance with an embodiment.

FIG. 11 is an annotated cross-sectional side view of the printing nozzle system 100 shown in FIG. 8 for a metal-based pellet extrusion additive manufacturing system, in accordance with an embodiment.

FIG. 12 is a flowchart illustrating an embodiment of a method 1200 for fabricating an object using a metal-based pellet extrusion additive manufacturing system.

FIG. 13 is a schematic perspective of one type of screw that may be used for the metal-based pellet extrusion additive manufacturing system.

FIG. 14 is a graph illustrating the temperatures for heat-treating and finishing a printed object following its fabrication in a method for using the metal-based pellet extrusion additive manufacturing system.

### DETAILED DESCRIPTION

It is to be understood that the figures and descriptions of the present invention may have been simplified to illustrate elements that are relevant for a clear understanding of the present invention, while eliminating, for purposes of clarity, other elements found in a typical 3D printer or typical method of using/operating a 3D printer. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

Before explaining at least one embodiment in detail, it should be understood that the inventive concepts set forth herein are not limited in their application to the construction details or component arrangements set forth in the following description or illustrated in the drawings. It should also be understood that the phraseology and terminology employed herein are merely for descriptive purposes and should not be considered limiting.

It should further be understood that any one of the described features may be used separately or in combination with other features. Other invented systems, methods, features, and advantages will be or become apparent to one with skill in the art upon examining the drawings and the detailed description herein. It is intended that all such additional systems, methods, features, and advantages be protected by the accompanying claims.

For purposes of this disclosure, the phrases “3D printer” and “additive manufacturing system” may be used interchangeably. Also, the phrases “printing bed”, “printing platform”, and “printing table” may be used interchangeably.

Embodiments of the present disclosure define a fused pellet fabrication (FPF)-style 3D printer system 1000 that, due to the totality of the configuration improvements, achieves improved economic and system capabilities, among other advantages. The resulting printed objects are made without the use of a mold. This is in contrast to using metal-based pellets in an injection molding scenario via employing a hollow container to catch the molten metal-plastic extruded material, which is a widely known technique.

In one example, a printed object 300 is formed from a metal-based pellet feedstock that is fed into the printing nozzle system 100 through a pellet hopper 102 or other equivalent materials feed system. The pellet feedstock can be a mixture of metal powder as a primary material and various binder materials that are integral and homogenous with the primary material. In one aspect, the output of the printing nozzle system 100 yields a three-dimensional “green” object or part 300. The various binder materials are then removed from the primary material in a subsequent phase where the printed part transitions from the “green” printed state, through a de-bind process (“brown” state) and sintering process (material densification), which removes the binder material(s), to allow the primary material to collapse upon itself yielding a three-dimensional solid metal part exhibiting material properties at or near the wrought material strength.

In referring to materials, the use of the term “green” means that the material has been printed but has undergone no further process to remove any binding material. By using the term “brown”, it is understood that the printed material has been printed and undergone a debinding process, but has not received any additional heat treatment or other processing. Referring to a material as “finished” means that the printed material that undergone printing, debinding, and sintering heat treatment (and any other further treatments) to fully densify the printed object.

In a non-limiting example, the material porosity following the debinding process may range from 16% to 17%, while the porosity following the sintering process may range from 1% to 2%. Additional processing may occur after sintering, such as sanding the printed object 300 or polishing the printed object 300. The debinding material is removable by a catalytic process. The catalyst that is used for debinding can be nitric acid and can be used in the CataMIM® debinding method. In one example, nitric acid at a 2 percent (%) concentration is used during the debinding operation. During debinding, nitrogen gas can be used to prevent oxidation of the metal.

Embodiments of the present disclosure also describe a system that is capable of allowing the FPF process to print most common polymer-based pellet-form feedstocks at a significant reduction in material costs. The elimination of the common FFF filament feedstock also allows for a significant reduction in polymer material cost.

Embodiments of the present disclosure further describe a system 10 that is capable of printing at a much faster rate than FFF-style printers due to the elimination of the filament and the addition of expanded extrusion zones and material feed mechanisms. This is accomplished while maintaining part surface smoothness associated with much slower print speed protocols.

In addition to the ability to 3D print and post-process material to ultimately yield a solid or near-solid metal part, embodiments of the present disclosure are capable of printing 3D parts that are: (1) relatively large (for example, 3×3×2 feet, or more), although smaller parts may be contemplated as well; (2) metal or polymer/composites; (3) at economic levels that are lower than parts currently made using more traditional metal processing techniques; and (4) capable of producing solid metal parts or products that are manufactured (printed) but also takes advantage of FFF 3D printing's promise of mass-customization which is another significant advancement in the state-of-the-art.

Embodiments of the present disclosure achieve at least: Use of metal-based pellets to FPF print 3D shapes. This ultimately results in an ability to use an FPF-style 3D printer to print solid metal parts. The 3D printed part (i.e., the green part—which is a common term in the art)) goes through a post-print process similar to metal injection molding (MIM) to yield the solid part from the 3D printed green part. The metal-based pellets may comprise, for example, stainless steel, copper, aluminum, titanium, cobalt, chromium, magnesium, nickel and many more fusible metal materials such as glass, ceramic or sand. The metal-based (fusible material) pellet will also comprise various binders such as polypropylene, polyethylene, polyoxymethylene (POM), waxes, or other similar materials. The fusible material (metal etc.) may be, for example, of any size, shape, weight, and/or density, as are currently used in state-of-the-art metal injection molding (MIM) processes, although sizes larger than the current MIM process are also possible.

Some benefits of embodiments of the present disclosure are: increased machine throughput from less than 1-2 lbs./hour to 8-10 lbs./hour or more while maintaining a high level of surface smoothness and material strength; increased versatility in the variety of polymers that can be used; and decreased material costs for the polymers and the metals used. Furthermore, the present invention allows 3D printing to be used for more general industrial applications and thereby opens up a much larger portion of the general manufacturing market to 3D printing due to the use of lower material costs and higher machine throughputs.

An additional benefit of the present disclosure is the ability to produce a single printed object design without requiring any welds, rivets, fasteners, or any other attachment means. As such, a monolithic printed object results while having strength properties nearing that of the wrought strength of a typical solid metal part.

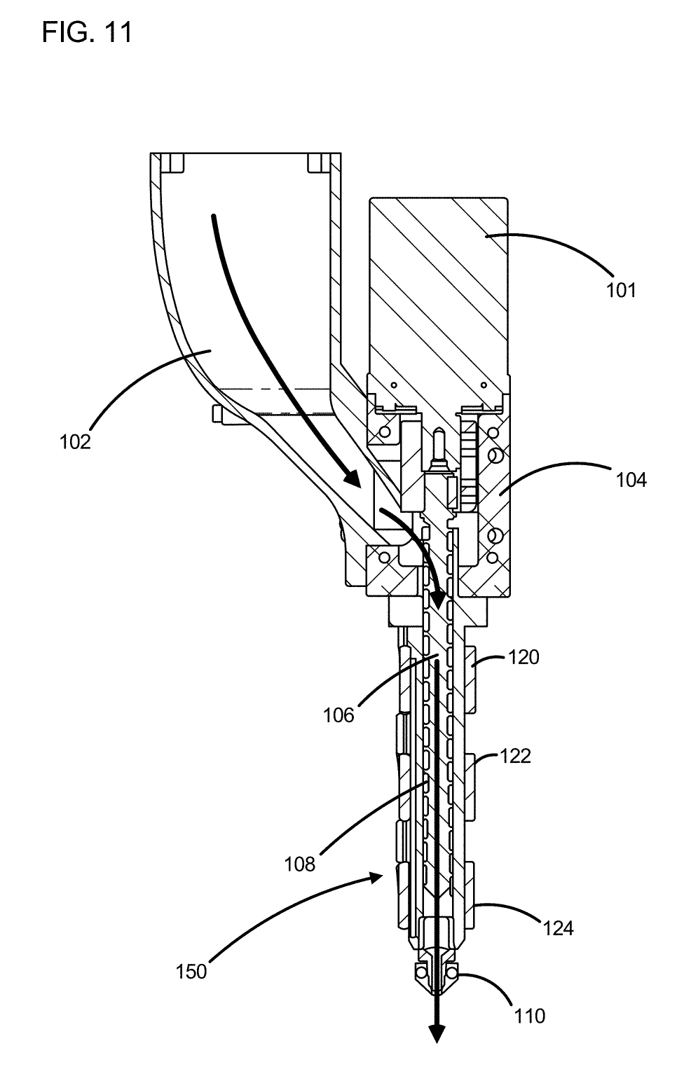

In operation, a screw extruder, such as screw 106 illustrated in FIG. 11, is the hardware mechanism within the printing nozzle system 100 that acts as an auger that causes the pellets 112 to travel down the length of the screw 106 (along the threads of the screw 106 during the rotation of screw 106) towards the end of nozzle 110. As the pellets 112 travel down the length of the screw 106, they are melted via shear forces developed by the rotating screw against the pellets and by at least one heater (three of which are employed in FIG. 11 and labeled 120, 122, or 124), until the pellets 112 are liquid as they exit the nozzle 110. Examples of pellets that may be used include 316L stainless steel MIM pellets, or 17-4 stainless steel pellets, which may be manufactured by Ryer, Inc in California.

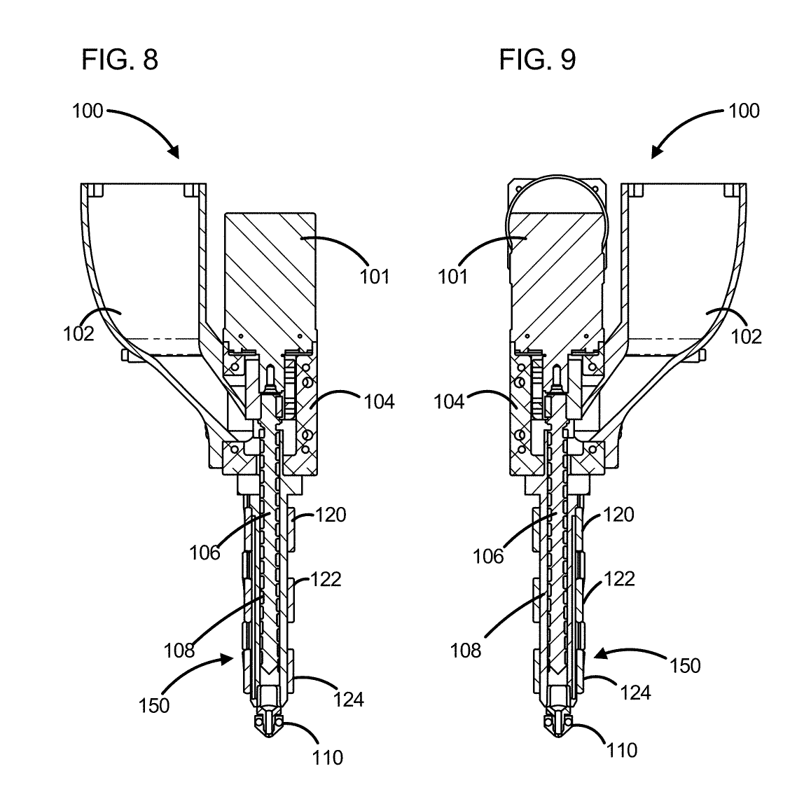

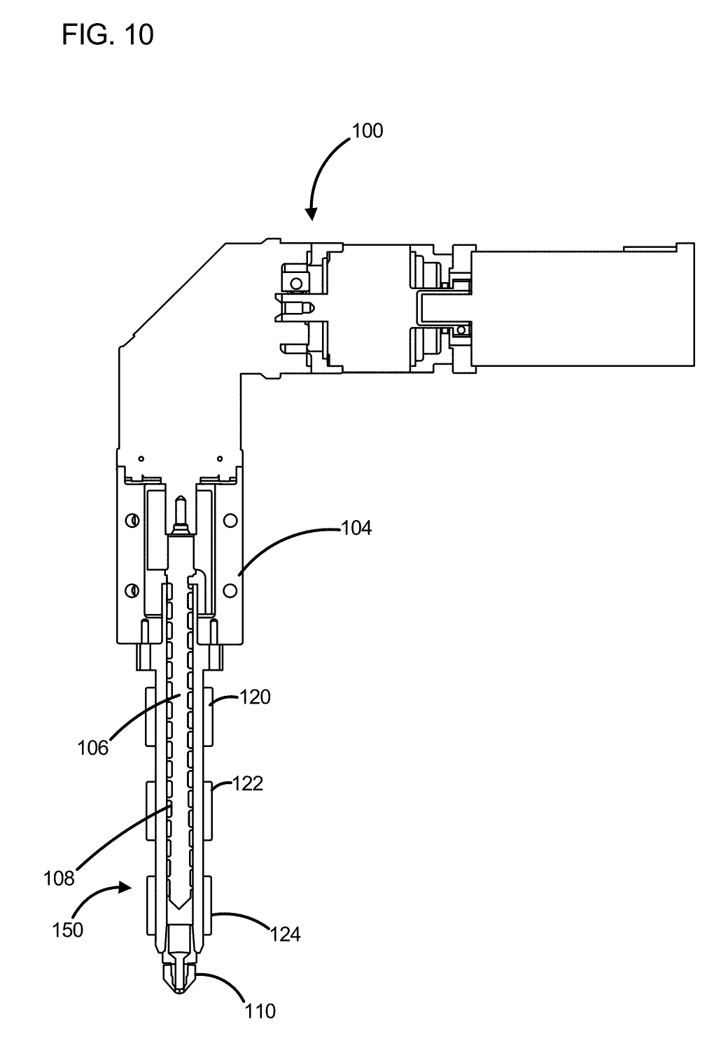

Embodiments are directed to a metal-based pellet extrusion additive manufacturing system for fabricating an object. The metal-based pellet extrusion additive manufacturing system comprises: a printing nozzle system 100 (such as that illustrated, in sectional view, in FIGS. 8-11) configured to extrude metal-based pellets 112. The extruded metal-based pellets form a 3D-printed object.

In an embodiment, the printing nozzle system 100 comprises a turnable screw 106, extruder body 104, and a nozzle 110. The turnable screw 106 is configured to transport the metal-based pellets 112 from an extruder body 104 towards a nozzle 110. The printing nozzle system 100 may further comprise at least one heater 120, 122, or 124 which at least partly surrounds a barrel 108 which houses screw 106. The at least one heater 120, 122, or 124 is configured to heat the metal-based pellets 112 while the metal-based pellets 112 are transported from the extruder body 104 towards the end of nozzle 110.

In the illustrated embodiments, three separate heaters 120, 122, and 124 are provided. However, fewer or more heaters may be utilized in some applications. The heaters 120, 122, and 124 may be electrically-powered.

In an embodiment, the 3D-printed object 300 may be a green part or may be a final part. The 3D-printed object may also be configured to yield a fully densified part after de-binding the binder(s) and sintering of the 3-D printed object, in a secondary post-print operation. A fully-processed part may have 1% to 2% porosity. Printed object 300 may be formed without any welds, rivets, fasteners, or any other attachment means.

In an embodiment, each metal-based pellet comprises (a mixture of) metal powder and binder in a typical ratio of 80% nominal by weight metal to 20% nominal by weight binder and other materials. In another embodiment, there is a primary binder and a secondary or skeletal binder. One example of a primary binder may be POM, and one example of a skeletal binder may be polyethylene. In an example, the printed object has an amount of metal is 60% by volume, the primary binder is 33% by volume, and the skeletal binder is 7% by volume. Other combinations are possible. In one example, the metal pellet is 316L stainless steel, the primary binder is POM, and the skeletal binder is polyethylene at the above-identified percentages. In yet another example, the metal pellet is 17-4 stainless steel, the primary binder is POM, and the skeletal binder is polyethylene at the above-identified percentages.

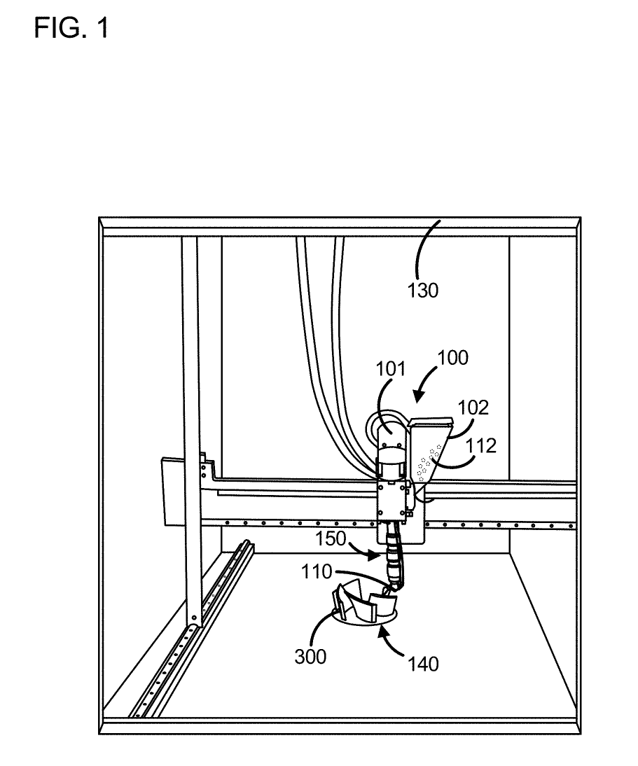

FIG. 1 illustrates a non-limiting embodiment with 3d printer 1000 having a printing nozzle system 100 in heated chamber 130. Printing nozzle system 100 may have a motor or gearbox 101, a hopper 102 for feeding metal-based pellets 112, and a printing head assembly 150 that includes a nozzle 110. The printing nozzle system 100 deposits the product 300 onto a bed 140. Motion control of any components for the printing nozzle system 100 may be effectuated via servo motors controlled by the controller 500 (discussed below). Motion through nozzle 110 may also be regulated under a number of different methods, such as those disclosed in U.S. Provisional Patent Application No. 62/735,342, which is incorporated by reference herein.

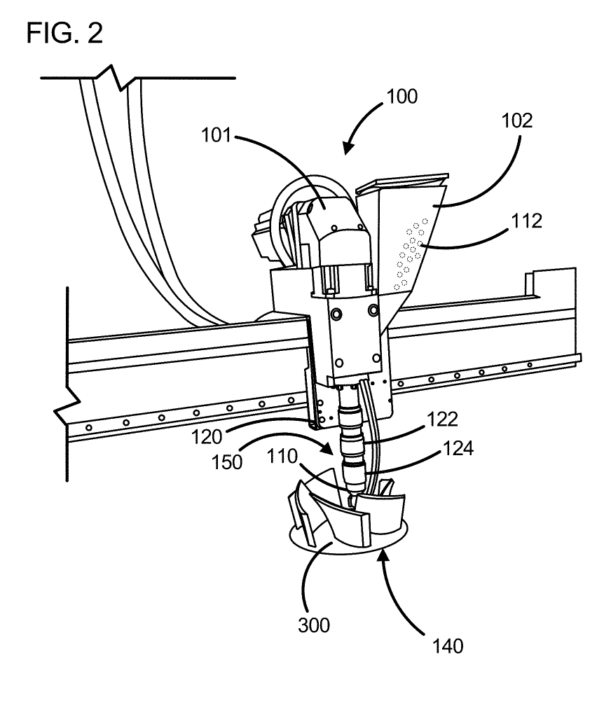

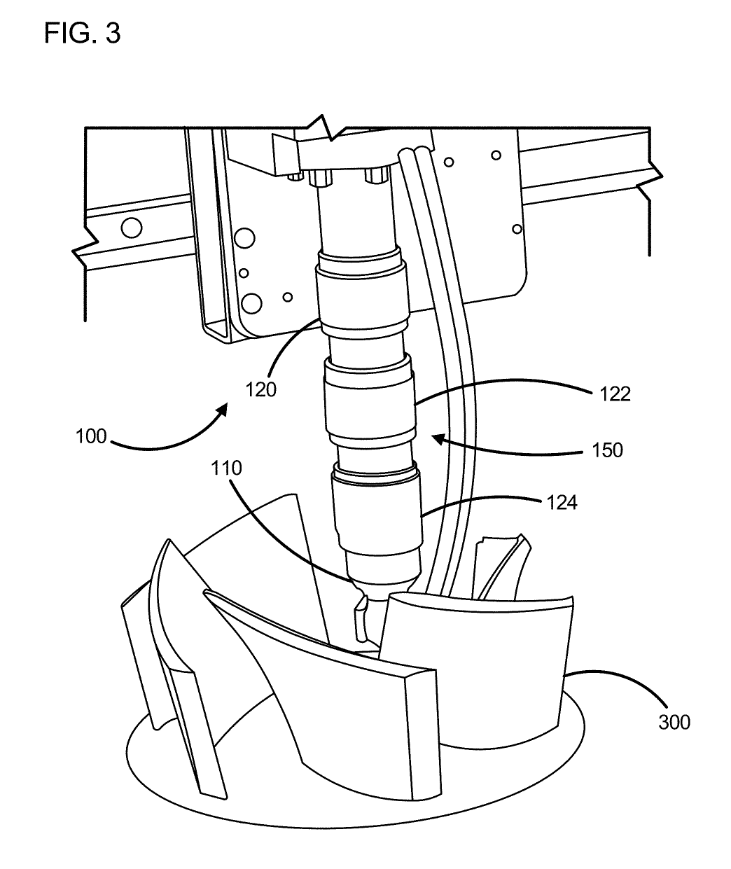

FIG. 2 is a magnified view of the printing nozzle system 100 of FIG. 1. Heaters 120, 122, and 124 for printing head assembly 150 are also visible in FIG. 2. FIG. 3 is a magnified view of the printing head assembly 150 in FIGS. 1 and 2. Heaters 120, 122, and 124 for printing head assembly 150 are also visible in FIG. 3, as are the contours of product 300 deposited on bed 140.

As shown in FIGS. 1-3. the printing nozzle system 100 for 3d printer 1000 may be enclosed within heated chamber 130 for depositing the extruded metal. The heated chamber 130 temperature may vary from 0° C. to 60° C. The extruded metal product 300 is deposited onto bed 140. The temperature of bed 140 may vary from 0° C. to 130° C.

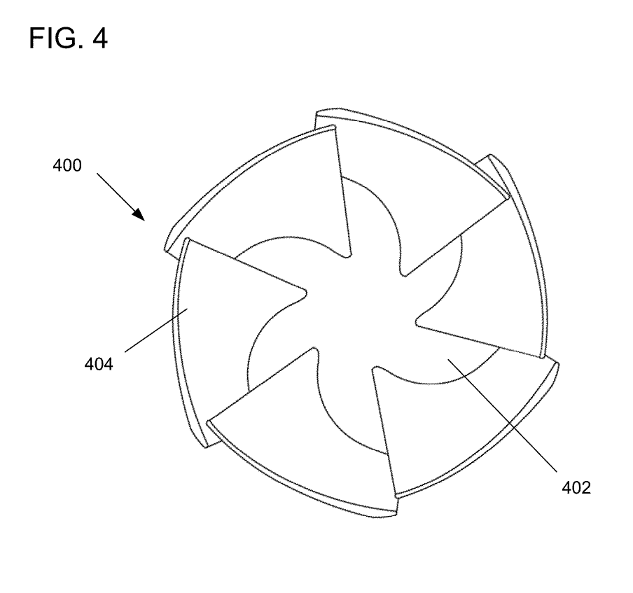

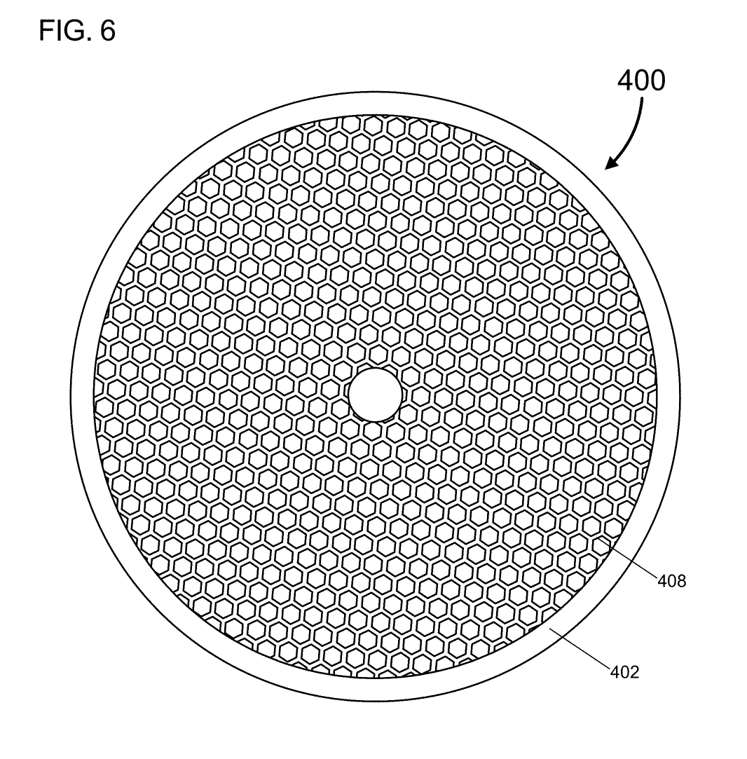

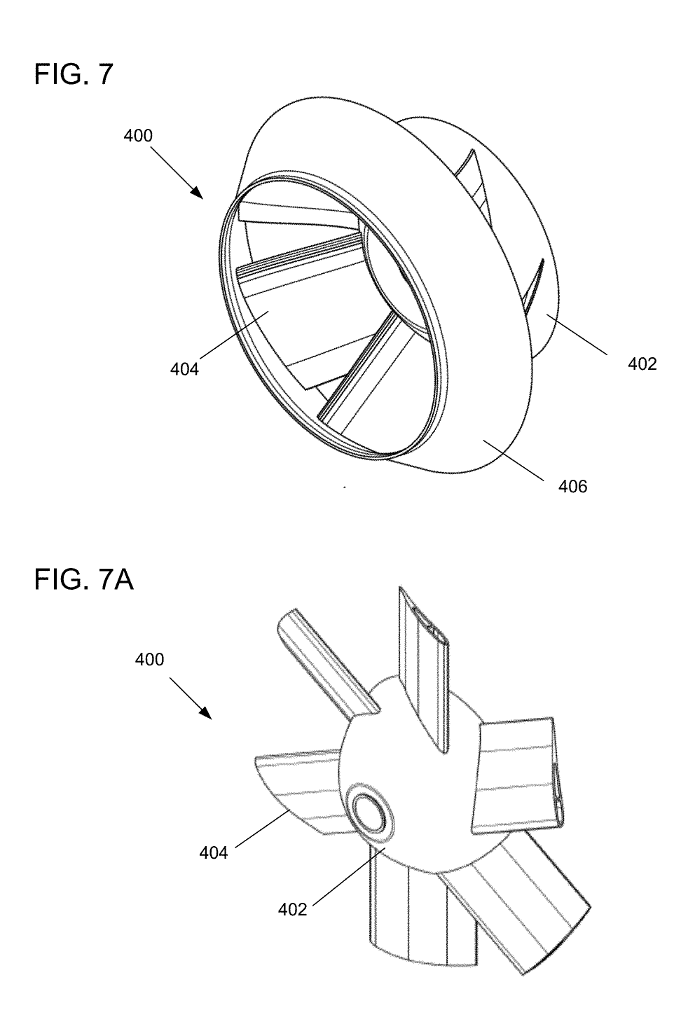

Printing nozzle system 100 may be used to produce several metallic products by extrusion of metal-based pellets in an additive manufacturing system. Such a metallic product, for example, may be a metallic fan wheel 400 illustrated in FIG. 4. FIG. 6 illustrates a rear view of the metallic fan wheel shown in FIG. 4. As shown, the fan wheel 400 includes a base 402 from which a plurality of fan blades 404 extend. The base 402 may be printed to have a frustoconical shape or a truncated dome shape and may also be printed to have a central aperture to receive a shaft, such as a motor shaft. In some examples, the base 402 can be printed to include a central shaft. In one example, the base 402 is printed such that the base is hollow. As can be seen at FIG. 6, the base 402 is hollow and is printed to include a support structure 408 along the bottom plane of the base 402. The support structure 408 gives the base 408 additional structural strength. In the example shown, the support structure 402 is a lattice-type structure with a honeycomb pattern. The support structure 402 can be formed as a planar structure with a constant or limited thickness, as shown, or can be printed throughout the entire hollow portion of the base such that the support structure fills the internal cavity defined by the base 402. The disclosed apparatus and process can be utilized to generate a number of different types of objects and fan wheels. For example, FIG. 7 shows an exemplary mixed-flow fan wheel 400 having a base 402, a plurality of fan blades 404, and a wheel cone 406. In one aspect, the base 402 is printed to have a frustoconical shape and the fan blades 404 are printed to have an airfoil shape. Another example fan wheel 400 is shown at FIG. 7A. In this example, a dome-shaped base 402 is printed with airfoil shaped blades 404 to result in an axial flow type fan wheel 400. Each of the fan wheels schematically shown at FIGS. 7 and 7A are also printed to have a central aperture to receive a shaft and can also be provided with a hollow base 402 with or without a support structure 408, as previously described for the example shown at FIG. 4. Other types of fan wheels 400 may also be printed using the disclosed apparatus and methods, for example, centrifugal-type fans. Although fan wheels 400 are shown as examples of printed objects 300, the disclosure should not be taken to be limited to this one particular implementation.

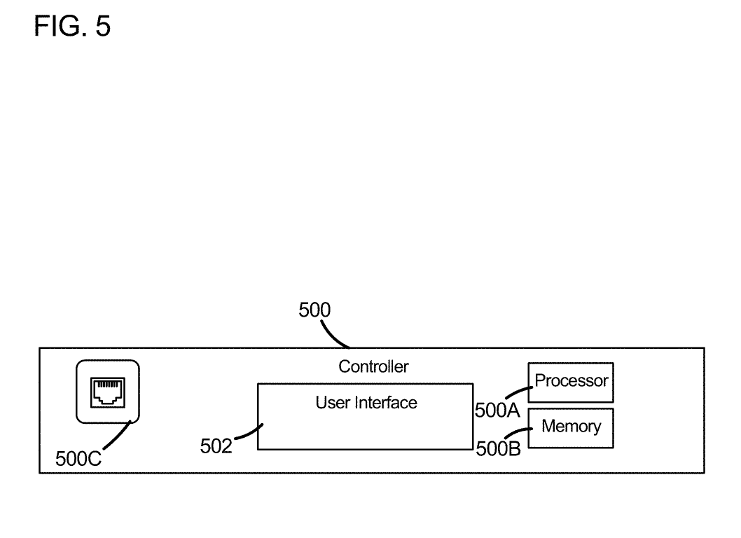

FIG. 5 is a schematic of the control system 500 of printing nozzle system 100, which is illustrated in FIGS. 1-3. Control system 500 is discussed in greater detail later in this application.

Referring to FIGS. 8-10, the printing nozzle system 100 may include a motor/gearbox 101, a pellet hopper 102, an extruder body 104, a turnable screw 106 for extruding the metal-based pellets, a barrel 108 for housing the screw 106, and a nozzle 110. Along barrel 108, there may be one or more heaters that can provide heat to barrel 108. By non-limiting example, FIGS. 8-11 illustrate embodiments where there are three heaters 120, 122, and 124. Screw 106 acts as an auger to extrude the metal-based pellets into the region heated by heater 122.

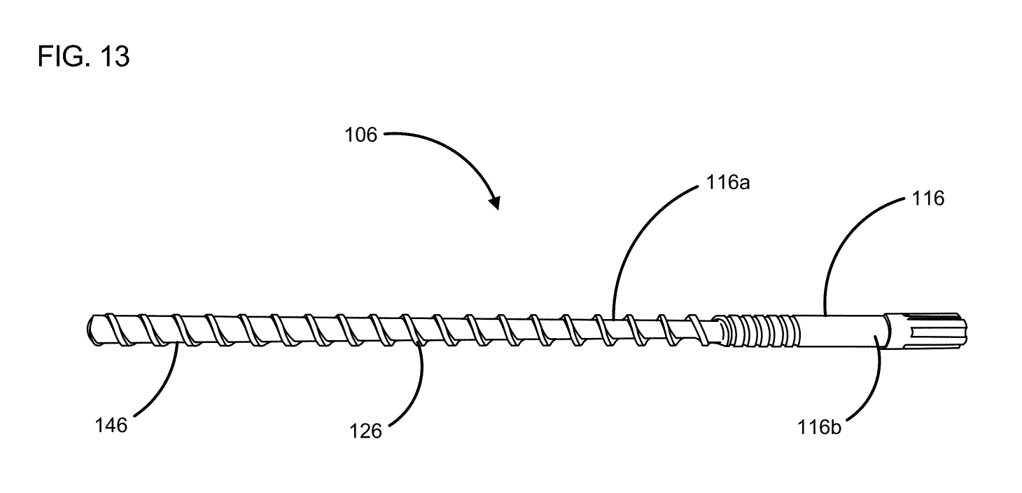

With reference to FIG. 13, the screw 106 is shown in isolation such that the features of the screw 106 can be more easily viewed. In one aspect, the screw 106 has a shank 116 with a threaded portion 116a and a non-threaded portion 116b. The threaded portion 116a includes threads 126 which extend from an end of the threaded portion 116a to the non-threaded portion 116b of the shank 116. In one aspect, the outer or major diameter of the threads 126 is constant such that the distance between the outer edge of the threads 126 and the interior surface of the barrel 108 is also constant. The minor diameter of the screw, or the diameter of threaded portion 116a of the shank 116 may vary depending upon the location of the shank 116. In the example presented, the threaded portion 116a of the shank 116 tapers in a direction from the end of the threaded portion 116a of the shank 116 towards the non-threaded portion 116b such that that the minor diameter of the threads 126 likewise decreases in the same direction. With such a configuration, the pellets 112 can be most easily received by the screw 106 at the beginning of the threaded portion 116a (i.e. at the junction of the threaded and non-threaded portions 116a, 116b).

The emitted heat from heater 120 may result in creating first heat zone having a temperature range between 150° C. and 230° C. The emitted heat from heater 122 may result in creating a second heat zone having a temperature range between 160° C. and 230° C. The emitted heat from heater 124 may result in creating a third heat zone having a temperature range between 180° C. and 230° C. In addition, a fourth heat zone located at nozzle 110 may have a temperature range between 180° C. and 245° C. After passing through heater 124, the extruded pellets pass through nozzle 110. The nozzle 110 may have an orifice size between 0.5 mm and 3 mm.

The extrusion process may result in printing a continuous stream at a speed of 1000 mm/minute to 10,000 mm/minute. These ranges may vary depending upon the MIM material that is extruded. In certain embodiments, printing speeds may also vary from 1500 mm/minute to 3100 mm/minute.

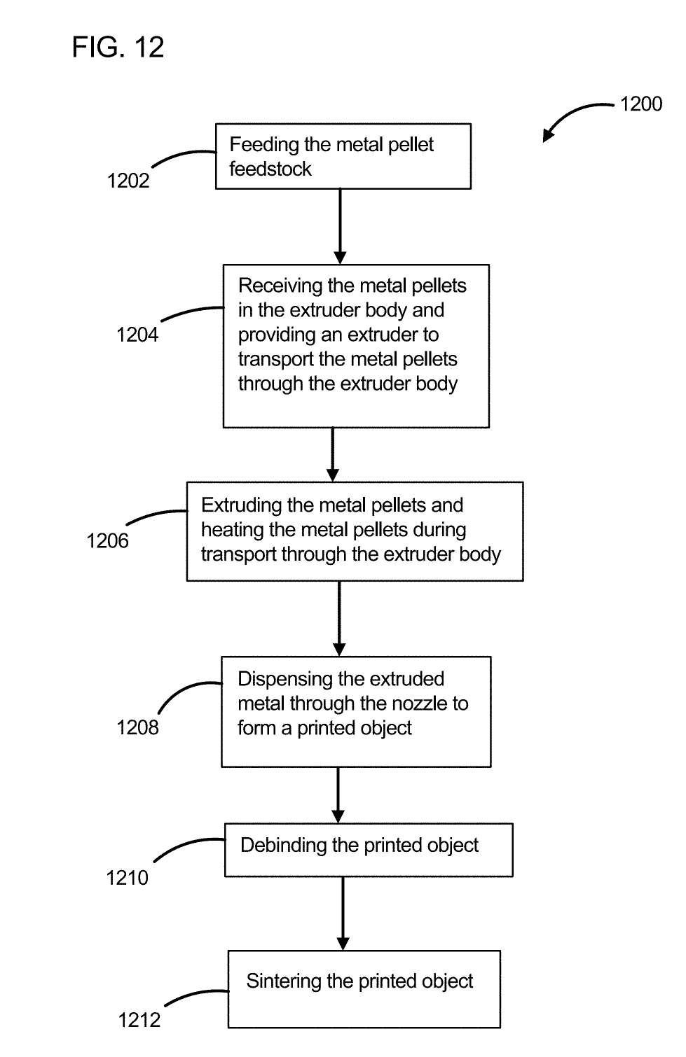

FIG. 12 illustrates a method 1200 for fabricating an object using metal-based pellet extrusion. Method 1200 may begin at step 1202, by feeding the feedstock pellets. Such metal-based pellets may be, for example, metal injection molding pellets with approximate dimensions of 2.5 mm by 2.5 mm. Step 1204 includes receiving the metal-based pellets in the extruder body 104 and providing an extruder, such as the turnable screw 106, to force the pellets through extruder body 104. In step 1206, the metal-based pellets are extruded and heated using one or more heaters during transport through the extruder body 104. In step 1208, the extruded material is dispensed through nozzle 110 and deposited onto surface 130 to form a printed object 300. Upon its completion, the printed object 300 is debinded in step 1210 to remove the wax or polymeric binder from the printed object 300. Finally, in step 1212, the printed object is sintered.

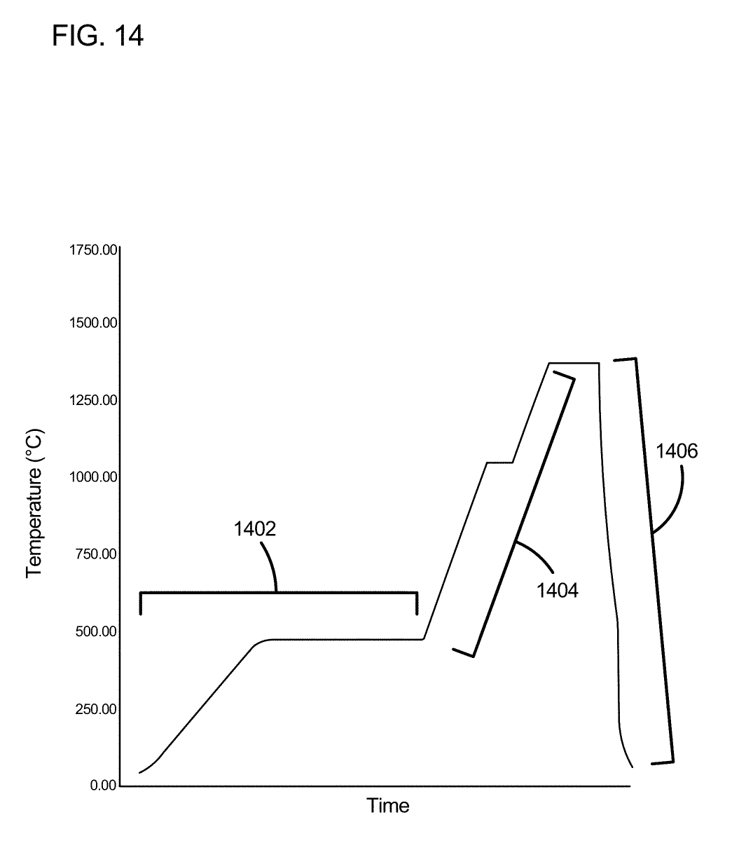

In one example of the method for fabricating an object using metal-based pellet extrusion, and as illustrated in FIG. 14, 17-4 type pellets manufactured by Ryer may be used to form a printed object 300. Printed object 300 may have an initial temperature of 200° C. (e.g. exiting temperature of material leaving the nozzle) in the green state. When printed object 300 undergoes debinding, as show in region 1402 of FIG. 14, the object 300 is heated in the presence of a catalyst and nitrogen process gas to a temperature of about 450° C. to 475° C. and held at this temperature range for at least about 3 hours, and preferably for about 5 hours. As stated previously, the presence of nitrogen gas prevents oxidation of the metal while the catalyst functions to remove the binder material. After debinding has finished, the printed object undergoes sintering, show in region 1404 of FIG. 14, and which is a more intense heat treating process. The temperature of printed object 300 is raised from about 475° C. to about 1070° C. in about one hour in the presence of nitrogen process gas, and the temperature is held constant for about 30 minutes. The temperature is increased further to about 1370° C. over a thirty-minute time period, and the temperature is held constant at about 1370° C. for another hour. To conclude the sintering process, cooled argon gas is introduced in the environment to purge the chamber of hydrogen while the temperature is quickly decreased to about 65° C. in about one hour, as shown in region 1406 of FIG. 14.

The process parameters may be controlled to optimize certain features of the printed object 300, such as the smoothness. In one example, surface smoothness for printed object 300 may be enhanced by printing the material with a layer height of about 0.5 mm. In other example, the layer height may be within the range of 0.5 mm to 1.0 mm. In yet other examples, the width of the stream of printed material may be from about 2.5 mm to about 3.2 mm.

Although embodiments are described above with reference to a 3D printer that uses metal-based pellets that includes a plastic binder as part of the pellet material, other material(s) besides (or in addition to metal) may alternatively be employed instead of or in combination with the binder(s) such as glass, ceramic, sand, combinations thereof, or any other fusible material, in any of the configurations and embodiments described above. Other alternatives or additions to the plastic binder such as clay, wax, polymer, combinations thereof, etc., may alternatively or additionally be employed, in any of the configurations and embodiments described above.

Although embodiments are described above with reference to a 3D printer that uses a nozzle system comprising a screw-type extruder, other type of extruders (such as non-screw-type extruders) may alternatively be employed, in any of the configurations and embodiments described above. For example, a ram extruder may be used instead of a screw.

Control System 500

Referring to FIG. 5, printing nozzle system 100 may also include an electronic controller 500. The electronic controller 500 is schematically shown as including a processor 500A and a non-transient storage medium or memory 500B, such as RAM, flash drive or a hard drive. Memory 500B is for storing executable code, the operating parameters, and the input from the operator user interface 502 while processor 500A is for executing the code. The electronic controller is also shown as including a transmitting/receiving port 500C, such as an Ethernet port for two-way communication with a WAN/LAN related to an automation system. A user interface 502 may be provided to activate and deactivate the system, allow a user to manipulate certain settings or inputs to the controller 500, and to view information about the system operation.

The electronic controller 500 typically includes at least some form of memory 500B. Examples of memory 500B include computer readable media. Computer readable media includes any available media that can be accessed by the processor 500A. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the processor 500A.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The electronic controller 500 is also shown as having a number of inputs/outputs that may be used for operating the printing nozzle system 100. The printing head assembly 150 may include pressure and sensor sensors that provide an input to the controller 500. The printing head assembly 150 can also include inputs and outputs, such as an output to control the operation of the actuator for the screw 106. The controller 500 can also include additional inputs and outputs for desirable operation of the printing nozzle system 100 and related systems, for example motion control servo motors.

It's understood that the above description is intended to be illustrative, and not restrictive. The material has been presented to enable any person skilled in the art to make and use the concepts described herein, and is provided in the context of particular embodiments, variations of which will be readily apparent to those skilled in the art (e.g., some of the disclosed embodiments may be used in combination with each other). Many other embodiments will be apparent to those of skill in the art upon reviewing the above description. The scope of the embodiments herein therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method of producing a fan wheel for a fan assembly, the method comprising:
a) receiving metal-based pellets at a printing assembly including a nozzle and an extruder, the pellets including a metal material and a binder material;
b) extruding and heating the metal-based pellets at the extruder to convert the metal-based pellets to a liquid state material; and
c) dispensing the liquid state material from the nozzle to print the fan wheel, the fan wheel being a monolithic object including a base and a plurality of fan blades.

2. The method of claim 1, wherein the dispensing step includes printing the base to have a hollow shape.

3. The method of claim 2, wherein the dispensing step includes printing the base to have a truncated dome-shape or a frustoconical shape and includes printing the fan blades to have an airfoil shape.

4. The method of claim 1, further comprising:
a) debinding the fan wheel to remove a primary binder of the binder material from the fan wheel; and
b) sintering the fan wheel to remove a skeletal binder of the binder material to densify the fan wheel.

5. The method of claim 4, wherein the metal material is a stainless steel material, the primary binder is polyoxymethylene and the skeletal binder is polyethylene.

6. A metal-based pellet extrusion additive manufacturing system for fabricating an object, the metal-based pellet extrusion additive manufacturing system comprising:
a printing nozzle system configured to extrude metal-based pellets;
wherein the extruded metal-based pellets form a 3D-printed object.

7. The metal-based pellet extrusion additive manufacturing system of claim 6, wherein the printing nozzle system comprises a turnable screw, extruder body, and a nozzle end, and wherein the turnable screw is configured to transport the metal-based pellets from an extruder body towards a nozzle end.

8. The metal-based pellet extrusion additive manufacturing system of claim 7, wherein the printing nozzle system further comprises at least one heater configured to heat the metal-based pellets while the metal-based pellets are transported from the extruder body towards the nozzle end.

9. The metal-based pellet extrusion additive manufacturing system of claim 8, wherein the heater is a band heater.

10. The metal-based pellet extrusion additive manufacturing system of claim 5, wherein the 3D-printed object is a green part.

11. The metal-based pellet extrusion additive manufacturing system of claim 9, wherein the metal-based pellets comprise a binder, and wherein the 3D-printed object is configured to yield a fully densified part after de-binding the binder and sintering of the 3-D printed object, in a secondary post-print operation.

12. The metal-based pellet extrusion additive manufacturing system of claim 6, wherein each metal-based pellet comprises metal powder and binder in a ratio of 80% by weight to 20% by weight binder.

13. A method for fabricating an object using metal-based pellet extrusion, the method comprising:
extruding metal-based pellets using a printing nozzle system to form a 3D-printed object.

14. The method of claim 13, wherein the printing nozzle system comprises a turnable screw, extruder body, and a nozzle end, and wherein the method further comprises transporting the metal-based pellets from the extruder body towards the nozzle end via the turnable screw.

15. The method of claim 14, wherein the printing nozzle system further comprises at least one heater which at least partly surrounds a barrel which houses the screw, and wherein the method further comprises heating the metal-based pellets via the at least one heater while the metal-based pellets are transported from the extruder body towards the nozzle end.

16. The method of claim 13, wherein the 3D-printed object is a green part.

17. The method of claim 16, wherein the metal-based pellets comprise a binder, and the method further comprises de-binding the binder and sintering the 3D-printed object to yield a fully densified part.

18. The method of claim 13, wherein each metal-based pellet comprises metal powder and binder in a ratio of 80% by weight metal to 20% by weight binder.

19. The metal-based pellet extrusion additive manufacturing system of claim 6, wherein fusible material-based pellets are substituted for the metal-based pellets, and wherein substituted fusible material of the fusible material-based pellets comprises a material selected from the group consisting of glass, ceramic, sand, and a combination thereof.

20. The method of claim 13, wherein fusible material-based pellets are substituted for the metal-based pellets, and wherein substituted fusible material of the fusible material-based pellets comprises a material selected from the group consisting of glass, ceramic, sand, and a combination thereof.
